(19) United States
(12) Patent Application Publication
(10) Pub. No.: US 2007/0266604 A1
(43) Pub. Date: Nov. 22, 2007

(54) Decorative and informative signage

(76) Inventor: Benjamin L. Garfinkle, Piedmont, CA (US)

Correspondence Address: Dergosits & Noah LLP, Suite 1450, Four Embarcadero Center, San Francisco, CA, 94111, US

(21) Appl. No.: 11/412,514

(22) Filed: Apr. 27, 2006

(51) Int. Cl. G09F 3/18

(52) U.S. Cl. 40/649

(57) ABSTRACT

A sign system for displaying product information proximate a product being vended. The sign system includes a base for maintaining a sign system at a predetermined orientation. A substantially planar face is appended to the base having a front surface and a rear surface. A primary sign is releasably retained to the front surface of the planar face, the primary sign having an opening or window therein. At least one channel is configured to the front or rear surface of the planar face and positioned substantially behind the opening or window of the primary sign. A secondary sign is releasably retained within the channel such that at least a portion of the secondary sign is visible through the opening or window in the primary sign.

### TECHNICAL FIELD

A sign system for displaying product information proximate a product being vended. The sign system includes a base for maintaining a sign system at a predetermined orientation. A substantially planar face is appended to the base having a front surface and a rear surface. A primary sign is releasably retained to the front surface of the planar face, the primary sign having an opening or window therein. At least one channel is configured to the rear surface of the planar face and positioned substantially behind the opening of the primary sign. A secondary sign is releasably retained within the channel such that at least a portion of the secondary sign is visible through the opening or window in the primary sign.

### BACKGROUND OF THE INVENTION

Retail establishments such as food markets vend upwards of thousands of items displayed on shelves and in display cases. Retail establishments carrying such products must not only be able to track them but must also be able to display them in conjunction with signage that is attractive and capable of differentiating brands or manufacturers.

Most grocery stores and food markets employ a computerized tracking system to enable a merchant to determine which products are successfully being purchased and which remain on store shelves. This information is critical to enable a vendor to maximize profitability by eliminating from store shelves those products which are not being purchased while enabling the vendor to efficiently reorder those products which its data system indicates are successful and thus being depleted in inventory. In this regard, reference is made to FIG. 1.

FIG. 1 depicts signage 10 which later will be referred to as a “secondary sign.” Signage 10 contains a good deal of information which is necessary for product tracking through computerized databases but which detracts from the visually appealing impact which product signage should otherwise embrace. For example, besides pricing information 12, signage 10 also includes a bar code 11 and complimentary serial number information 14. A PLU # is also provided in field 13 together with a statement of the product being tracked, in this case, “GRAPEFRUIT RED SMALL TEXAS.” Again, if such signage was to be placed within an easel-based holder or along a C-channel situated at the end of a grocery shelf, the fact that a certain variety of grapefruit is being sold at 0.99 each would at worst be lost in the background information displayed on the signage, or, at best, would not represent a visually impactful sign likely to attract a retail customer.

In addition to the desire to obfuscate a number of fields of signage 10, retailers have recognized that providing signage which is attractive as well as informative and stimulating is most likely to have the desired effect of promoting product sales. However, signage 10 is simply too small and crowded to enable a retailer to add any additional customer stimulating or attracting information thereto. This is not surprising considering that signage 10 was designed for placement on the edge of a shelf, positioned for a consumer to have very close eye contact. However, such signage, in and of itself, is not particularly appropriate for a highly stylized easel displays and the like.

It is thus an object of the present invention to provide signage which informs and attracts customers while taking advantage of product tracking information necessary for internal inventorying of goods.

This and further objects will be more readily appreciated when considering the following disclosure and appended claims.

### SUMMARY OF THE INVENTION

The present invention is directed to a sign system for displaying product information proximate a product being vended, said sign system comprising a base for maintaining said sign system in a predetermined orientation, a substantially planar face appended to said base and having a front surface and a rear surface, a primary sign releasably retained to said front, said sign having an opening or window through which information contained on a secondary sign can be seen. At least one channel is configured to the planar surface and positioned substantially behind said opening or window in said primary sign. A secondary sign is releasably retained within said channel such that at least a portion of said secondary sign is visible through said opening or window.

### BRIEF DESCRIPTION OF THE FIGURES

FIG. 1 is a front plan view of inventory signage typical of the prior art.

FIGS. 2A, 2B and 2C are front plan views of typical primary signage for use in carrying out the present invention.

FIG. 3 is a perspective view showing how the various elements of the present invention would be joined in creating the signage sought after herein.

FIG. 4 is a perspective view of the signage of FIG. 3 once assembled.

FIG. 5 is a perspective view of a second embodiment to the present invention.

FIGS. 6A and 6B are side views of the embodiment shown in FIG. 5 depicting two possible orientations of this assembly.

FIGS. 7 and 8 are perspective views showing signage corresponding to the present signage oriented as shown in FIGS. 6A and 6B, respectively.

### DETAILED DESCRIPTION OF THE INVENTION

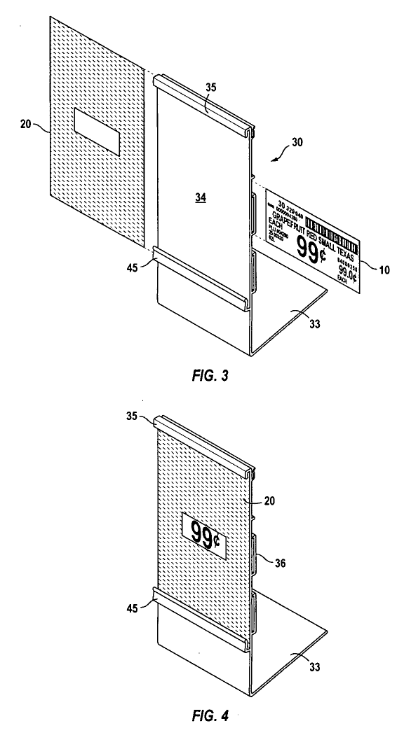

Turning first to FIGS. 3 and 4, sign system 30 is depicted. Such sign system includes base 33 for maintaining said sign system at a predetermined orientation. Base 33 can be an easel base and it can be, as depicted, an element injection molded or extruded with planar face 34 to constitute a single part. As noted, when base 33 is placed upon a horizontal surface, planar face 34 extends preferably at a slight angle from vertical towards the anticipated line of sight of a consumer.

Although primary sign 20 is shown without graphics or product identifying information, such information would, when commercially employed, be applied to the front face of sign 20 in field 21. It should be noted that the relative size of sign 20 with respect to secondary sign 10 enables a retailer to place a relatively large amount of graphical and informative information whereupon to both attract a retail customer and provide information such as whether the product being sold is “organic,” “fresh,” etc. Although primary sign 20 of FIGS. 2A and 3 is typical of its configuration in practicing the present invention, other iterations are certainly possible while remaining within the spirit and scope of the present invention. For example, FIG. 2B shows primary signage 25 wherein two openings or windows 27 and 28 are provided within field 26 while FIG. 2C shows signage 29 provided with opening or window 32 within field 31.

Turning once again to FIGS. 3 and 4, in use, primary sign 20 is shown releasably retained on the front surface of planar face 34. Ideally, primary sign 20 is sized such that ribs 35 and 45 are spaced apart from one another to frictionally capture and releasably retain signage 20 on the front surface of planar face 34.

To complete signage 30, secondary sign 10 is shown being capable of being releasably captured by channel 36, itself being located on either the rear or front surfaces of planar face 34. As shown in FIGS. 3 and 4, multiple channels 36 can be provided when employing, for example, primary sign 25 having two openings or windows 27 and 28.

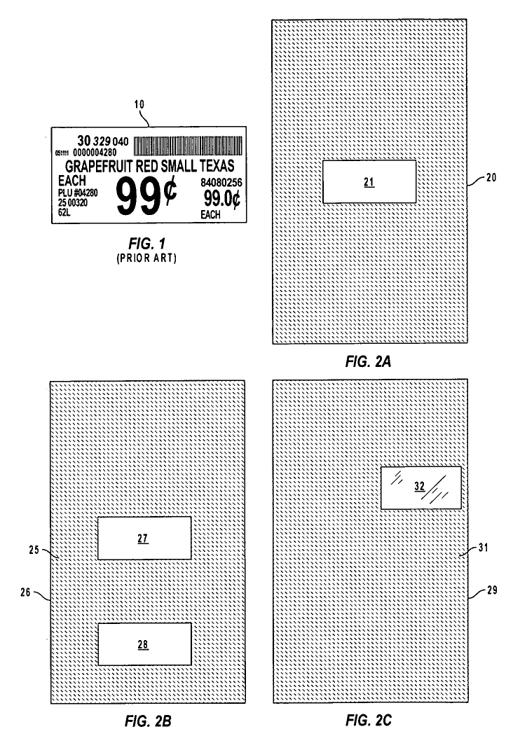

It is noted in comparing FIGS. 1, 3 and 4 that when secondary signage 10 is placed within channel 36 and behind primary sign 20, only the price of the product, in this case, 99¢, is visible to a consumer. All of the miscellaneous and detracting fields 11, 13, etc., have now been blocked from view by primary sign 20 and its strategically sized opening or window 22. Information such as the product being “grapefruit red small Texas” can be instead, artfully depicted on primary sign 20 while, in doing so, the product tracking and inventorying information contained on secondary sign 10 remains associated with the product for internal use by the retailer. It should be noted, however, that other secondary signage can be employed, such as original signage having nothing more than information imprinted thereon.

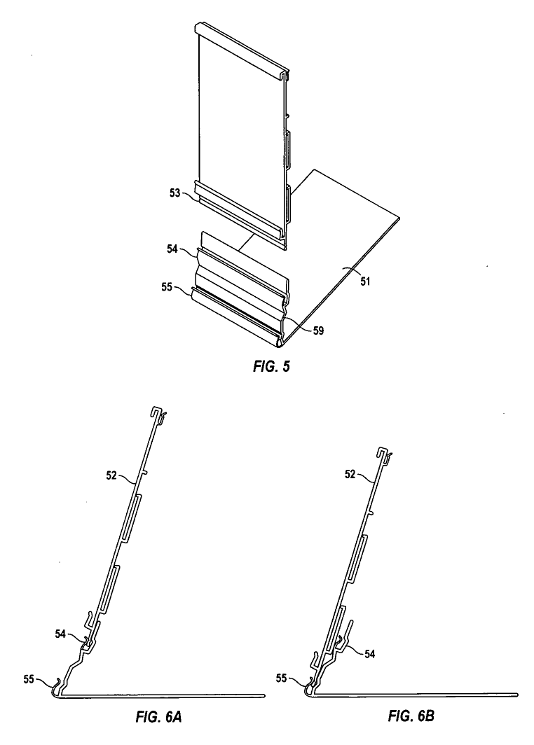

Although the embodiment of the present invention shown in FIGS. 3 and 4 depict a base and planar face as a single continuous part such as one which has been injection molded from clear plastic, the present invention also encompasses those embodiments shown in FIGS. 5 through 8.

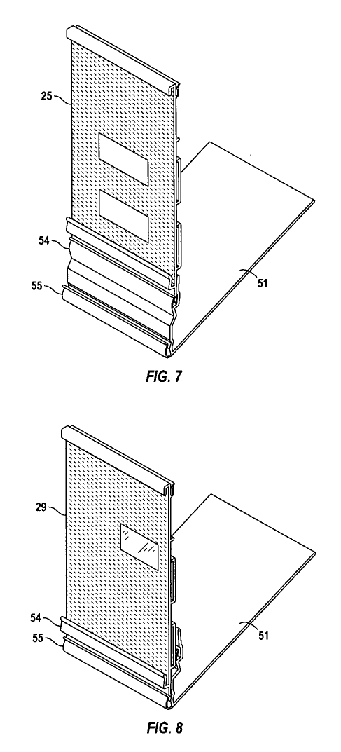

Turning to FIG. 5, easel base 51 is shown having an upturned section 59 intended to rest upon a shelf or flat surface in a display case. Continuing with the embodiment shown in FIG. 5, upturned section 59 includes clip channels 54 and 55 sized to receive a corresponding rail 53. In comparing FIGS. 6A and 6B, it is noted that the height of planar face 52 can be varied depending upon which clip channel 54 or 55 is used to engage rail 53. In doing so, one could achieve either embodiment shown in FIGS. 7 and 8, FIG. 7 corresponding to engagement shown in FIG. 6A while FIG. 8 depicts the engagement shown in FIG. 6B. Alternative primary signage such as that shown in FIG. 2B is illustrated as being supported in the embodiment of FIG. 7 while the primary sign of FIG. 2C is shown installed in the embodiment of FIG. 8. These illustrations are merely made to further highlight the flexibility of the present invention.

1. A sign system for displaying product information proximate a product being vended, said sign system comprising a base for maintaining said sign system in a predetermined orientation, a substantially planar face appended to said base and having a front surface and a rear surface, a primary sign releasably retained to said front surface, said primary sign having an opening or window therein, at least one channel configured to the front or rear surface of said planar face and positioned substantially behind said opening or window in said primary sign and a secondary sign releasably retained within said channel such that at least a portion of said secondary sign is visible through said opening or window.

2. The sign system of claim 1 wherein a pair of retaining ribs are configured on said planar face for releasably retaining and maintaining said primary sign.

3. The sign system of claim 1 wherein said opening or window in said primary sign is sized to enable a portion, but not all, of said secondary sign to be visible therethrough.

4. The sign system of claim 1 wherein said base is an easel base.

5. The sign system of claim 4 wherein said base and planar face are injection molded as a single element.

6. The sign system of claim 1 wherein said primary sign is provided with a plurality of openings or windows configured therein.

7. The sign system of claim 6 wherein channels are configured to the rear of said planar face positioned substantially behind each of said plurality of openings or windows.

8. The sign system of claim 1 wherein said base is provided with at least one clip channel for releasably receiving said planar face.

9. The sign system of claim 8 wherein said base is provided with a plurality of clip channels, each extending substantially parallel to one another and each for releasably receiving said planar face.

10. The sign system of claim 9 wherein the relative height of said planar face with respect to said base is adjustable by engaging said planar face with different clip channels.
